(19) United States
(12) Patent Application Publication
(10) Pub. No.: US 2017/0080866 A1
(43) Pub. Date: Mar. 23, 2017

(54) REAR-VIEW VERIFICATION DEVICE, AND AUTOMOBILE EQUIPPED WITH SAME

(71) Applicant: Panasonic Intellectual Property Management Co., Ltd., Osaka (JP)

(72) Inventors: JUN NAKAI, Kanagawa (JP); TAKASHI OKOHIRA, Kanagawa (JP)

(21) Appl. No.: 15/126,269

(22) PCT Filed: Apr. 1, 2015
(86) PCT No.: PCT/JP2015/001879

§ 371 Date: Sep. 14, 2016

(30) Foreign Application Priority Data
Apr. 3, 2014 (JP) 2014-076722
Apr. 4, 2014 (JP) 2014-077493

(51) Int. Cl. B60R 1/12; B60R 1/04; H04N 5/232; H04N 5/067; H04N 5/38; H04N 5/44; B60R 1/00; H04N 7/04

(52) U.S. Cl. CPC B60R 1/12; B60R 1/00; B60R 1/04; H04N 7/04; H04N 5/067; H04N 5/38; H04N 5/44; H04N 5/23293; B60R 2001/1215; B60R 2300/8066

(57) ABSTRACT

A rear-view verification apparatus includes a display apparatus and a camera apparatus. The display apparatus is mounted in front of a driver's seat inside a vehicle interior of a vehicle. The camera apparatus is coupled with the display apparatus and capable of shooting a rearview-image in a rearward direction of the vehicle. The display apparatus includes a landscape-oriented display device and a first controller coupled with the display device. The first controller causes the display device to display an image in accordance with an image signal fed from the camera apparatus. Then, the first controller expands the image such that the image is wider in a longitudinal direction when the image is displayed on either longitudinal side of the display device than when the image is displayed on the central part of the display device in the longitudinal direction.

### TECHNICAL FIELD

The present invention relates to a rear-view verification apparatus, which is also called “a rearview mirrors” for vehicles, and a vehicle equipped with the apparatus, for example.

### BACKGROUND ART

A rear-view verification apparatus, also called “a rearview mirror” for a vehicle, has been proposed which is capable of displaying a rearview-image that is shot with a camera apparatus, for example.

That is, the rear-view verification apparatus includes: a display apparatus mounted in front of the driver's seat of the vehicle interior of the vehicle; and a camera apparatus which is connected to the display apparatus and capable of shooting a rearview-image in a rearward direction of the vehicle. The apparatus is configured such that the rearview-image shot with the camera apparatus can be displayed on the display apparatus. (Patent Literature 1 indicated below is a prior art document relating to the technology similar to this.)

### CITATION LIST

### Patent Literature

PTL 1: Japanese Patent Unexamined Publication No. 2013-244752

### SUMMARY OF THE INVENTION

The present invention provides a rear-view verification apparatus that features ease of use.

The rear-view verification apparatus according to the present invention includes a display apparatus and a camera apparatus. The display apparatus is mounted in front of a driver's seat inside a vehicle interior of a vehicle. The camera apparatus is coupled with the display apparatus, and capable of shooting a rearview-image in a rearward direction of the vehicle. The display apparatus includes a landscape-oriented display device and a first controller coupled with the display device. The first controller causes the display device to display an image in accordance with an image signal fed from the camera apparatus. In addition, the first controller expands the image such that the image is wider in a longitudinal direction when the image is displayed on either longitudinal side of the display device than when the image is displayed on the central part of the display device in the longitudinal direction.

This configuration allows a driver to understand contents of the image in a state where the image is close to a real image, over the corresponding region from the central part of the landscape image displayed on the display device to both the longitudinal sides of the landscape image. As a result, this allows the driver to easily drive the vehicle appropriately. That is, the rear-view verification apparatus can feature excellent ease of use.

### BRIEF DESCRIPTION OF DRAWINGS

FIG. 1 is an elevational view of the vehicle interior of a vehicle that is equipped with a rear-view verification apparatus according to an embodiment of the present invention.

FIG. 2 is a plan view of the vehicle shown in FIG. 1.

FIG. 3 is a schematic side view of the vehicle interior of the vehicle shown in FIG. 2.

FIG. 4 is an elevational view of a display apparatus of the rear-view verification apparatus shown in FIG. 1.

FIG. 5 is a control block diagram of the rear-view verification apparatus according to the embodiment of the present invention.

FIG. 6 is an operation flowchart of the rear-view verification apparatus shown in FIG. 5.

FIG. 7 is a timing flowchart of the rear-view verification apparatus shown in FIG. 5.

FIG. 8 is a view illustrating an operation of the rear-view verification apparatus shown in FIG. 5.

FIG. 9A is a view illustrating the operation of the rear-view verification apparatus shown in FIG. 5.

FIG. 9B is a view illustrating the operation of the rear-view verification apparatus shown in FIG. 5.

FIG. 10 is a view illustrating the operation of the rear-view verification apparatus shown in FIG. 5.

### DESCRIPTION OF EMBODIMENTS

Prior to describing embodiments of the present invention, a problem of the conventional rear-view verification apparatus will be briefly described. The rear-view verification apparatus disclosed in Patent Literature 1 operates as follows: When a display apparatus displays an image signal shot with a camera apparatus, a part of the image is expanded in the up-and-down direction. The part to be expanded is a portion to be displayed particularly on a central part of a screen of the display apparatus. By the partial expansion, the image displayed on the screen central part is made closely similar to a real rearview-image.

However, in verifying the rear-view before changing a vehicle-traveling direction during an actual driving, for example, the similarity between the displayed rearview-image and the real rearview is more important for left-and-right directional parts of the image than for up-and-down directional parts of the central part of the image. If the left-and-right directional parts of the displayed rearview-image are distorted, and different from the real rearview, the user has a strong strange feeling that something is wrong and suffers from bad ease of use.

Hereinafter, examples in which a rear-view verification apparatus according to the embodiment of the present invention is mounted in a vehicle will be described with reference to the drawings.

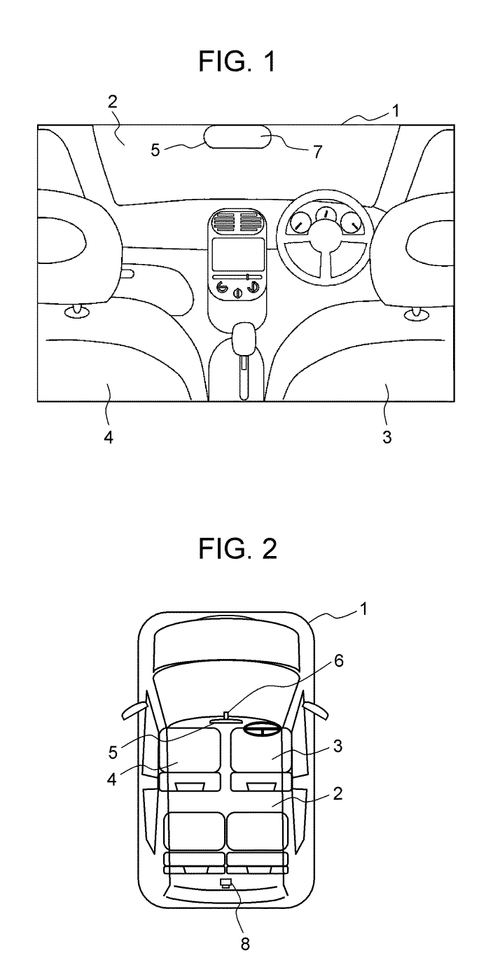

In FIGS. 1 to 3, in a front and upper area of a portion between driver's seat 3 and passenger seat 4 in vehicle interior 2 of vehicle 1, display apparatus 5 configuring the rear-view verification apparatus is mounted to mounting part 6, movably and adjustably (in terms of its tilting state).

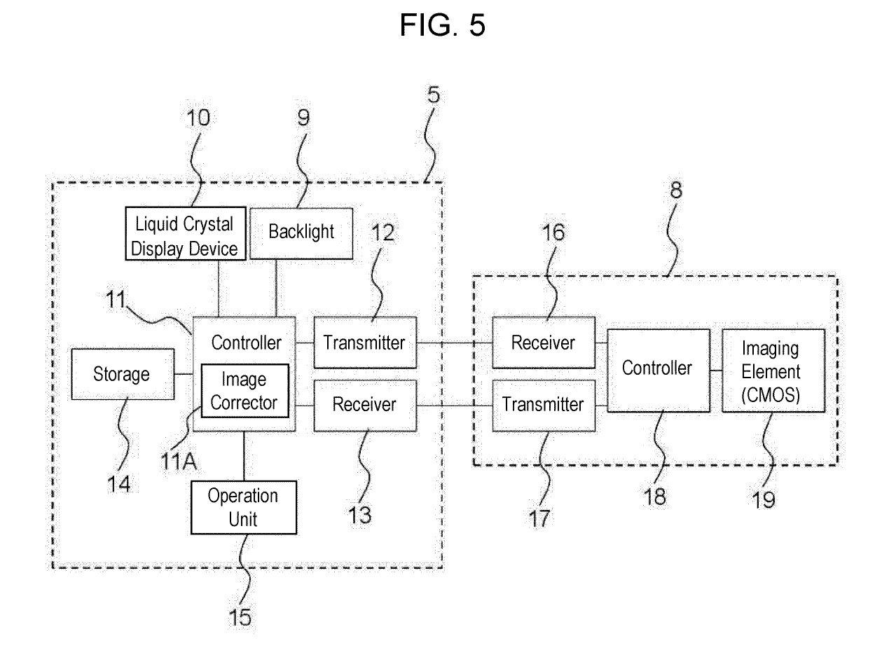

Display apparatus 5 is of a container shape having an opening on the driver's seat 3 side. In this opening, display device 7 having a landscape shape is mounted as shown in FIG. 4.

Display device 7 has a configuration, as shown in FIG. 5, for displaying an image shot with camera apparatus 8 that is capable of shooting a rearview-image in the rearward direction of vehicle 1.

That is, as shown in FIG. 5, display apparatus 5 includes: backlight 9 disposed in the inside of the apparatus; liquid crystal display device 10 disposed on the driver's seat 3 side of backlight 9; controller 11 coupled with backlight 9 and liquid crystal display device 10; transmitter 12; receiver 13; storage 14; and operation unit 15. Transmitter 12, receiver 13, storage 14, and operation unit 15 are coupled with controller 11. Controller 11, transmitter 12, receiver 13, and liquid crystal display device 10 correspond to a first controller, a first transmitter, a first receiver, and a display device, respectively.

Note that storage 14 stores an operation program, and operation unit 15 is used to turn a power switch between ON and OFF.

On the other hand, as shown in FIG. 5, camera apparatus 8 includes: receiver 16 to be coupled with transmitter 12 of display apparatus 5; transmitter 17 to be coupled with receiver 13 of display apparatus 5; controller 18 coupled with receiver 16 and transmitter 17; and imaging element 19 coupled with controller 18. Controller 18, transmitter 17, and receiver 16 correspond to a second controller, a second transmitter, and a second receiver, respectively.

That is, in the embodiment, controller 11 of display apparatus 5 transmits a synchronization signal to controller 18 of camera apparatus 8 via transmitter 12 and receiver 16, although details will be described later. Moreover, upon receiving the synchronization signal, controller 18 of camera apparatus 8 transmits an image signal to controller 11 of display apparatus 5 via transmitter 17 and receiver 13.

Then, in this state, controller 11 of display apparatus 5 is configured to sequentially transmit the image signals to liquid crystal display device 10 where the image signals are displayed thereon. That is, controller 11 causes liquid crystal display device 10 to display the image in accordance with the image signal fed from camera apparatus 8.

Note that, in the embodiment, imaging element 19 includes a complementary metal-oxide semiconductor (CMOS) sensor. A signal of a landscape area geometrically similar to landscape display device 7 is fed to liquid crystal display device 10 via controller 18, transmitter 17, receiver 13, and controller 11.

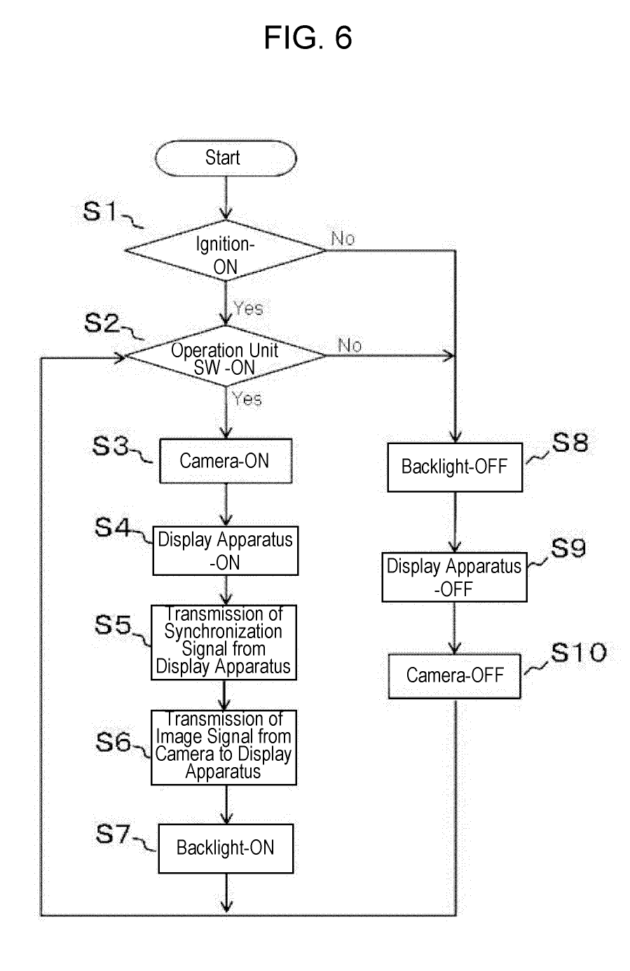

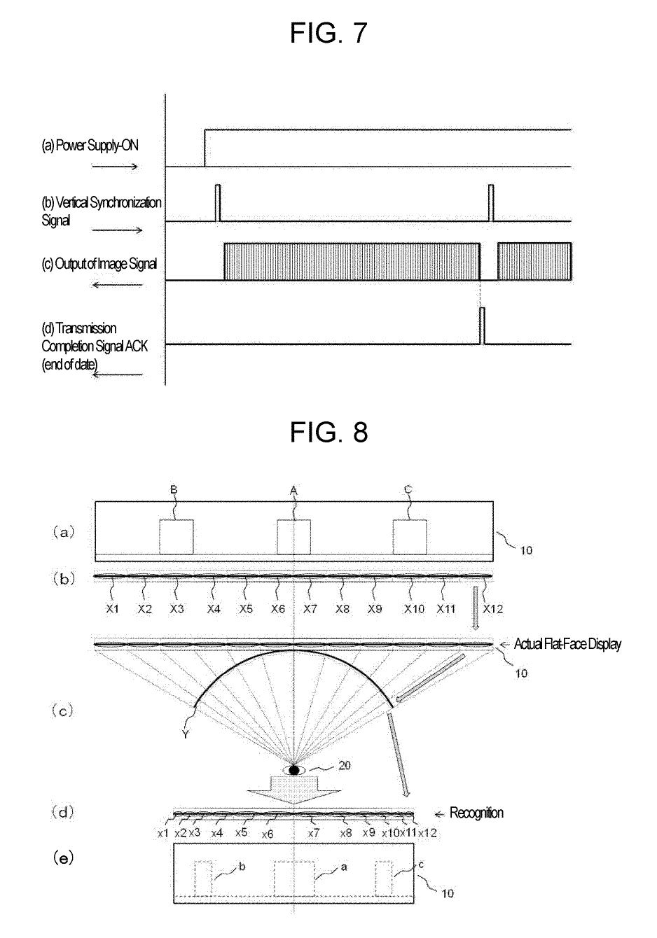

With the configuration described above, in the ON state of an ignition switch (not shown) of vehicle 1 (S1 of FIG. 6), the power switch is turned ON through an operation of operation unit 15 shown in FIG. 4 (“Yes” in S2 of FIG. 6), which allows power supply to camera apparatus 8 and display apparatus 5, resulting in an activated state thereof (S3 and S4 of FIG. 6, and (a) of FIG. 7).

The embodiment is characterized in that, when camera apparatus 8 and display apparatus 5 becomes in the activated state in this way, controller 11 of display apparatus 5 transmits a synchronization signal (vertical synchronization signal) to controller 18 of camera apparatus 8 via transmitter 12 and receiver 16, as shown in (b) of FIG. 7 (S5 of FIG. 6).

Moreover, upon receiving the synchronization signal fed from controller 11 of display apparatus 5, controller 18 of camera apparatus 8 transmits the image signal to controller 11 of display apparatus 5 via transmitter 17 and receiver 13, as shown in (c) of FIG. 7 (S6 of FIG. 6).

Upon receiving the image signal fed from controller 18 of camera apparatus 8, controller 11 of display apparatus 5 causes backlight 9 to be in the ON state and then sequentially supplies the image signals to liquid crystal display device 10 of display apparatus 5, after the image signals have undergone a correction by image corrector 11A, thereby causing the display device to display the image signals thereon (S7 of FIG. 6).

Moreover, at the end of one frame of the image signal generated by camera apparatus 8, controller 18 of camera apparatus 8 transmits a transmission completion signal for one frame of the image to controller 11 of display apparatus 5 via transmitter 17 and receiver 13, as shown in (d) of FIG. 7.

Then, controller 11 of display apparatus 5 transmits the next synchronization signal to controller 18 of camera apparatus 8 via transmitter 12 and receiver 16. From then on, the operations of FIGS. 6 and 7 are repeated.

That is, the configuration according to the embodiment is as follows: Controller 11 of display apparatus 5 transmits the synchronization signal to controller 18 of camera apparatus 8 via transmitter 12 and receiver 16. Controller 18 of camera apparatus 8 transmits the image signal to controller 11 of display apparatus 5 via transmitter 17 and receiver 13. Controller 11 transmits the image signal to liquid crystal display device 10 after the image signal has undergone the correction by image corrector 11A.

For this reason, there is no need for generating a one-frame screen on the display apparatus 5 side. As a result, there is few time lag between the displayed image and the real image, resulting in a less strange feeling for a driver with good ease of use.

Note that, when the power switch is turned OFF through an operation of operation unit 15 shown in FIG. 4 (“No” in S2 of FIG. 6), backlight 9 is turned OFF (S8 of FIG. 6). In addition, the power supply to display apparatus 5 and camera apparatus 8 is shut down, causing the both to be in the OFF state (S9 and S10 of FIG. 6).

As described above, in the embodiment, the image displayed on liquid crystal display device 10 exhibits few time lag with respect to the rearview-image, in the rearward direction of vehicle 1, shot with camera apparatus 8. This results in a less strange feeling for the driver with good ease of use.

That is, for example, when the driver looks in the display screen of liquid crystal display device 10 before changing a vehicle-traveling direction, the displayed image has few time lag behind the rearview-image, in the rearward direction of vehicle 1, shot with camera apparatus 8. Such few time lag gives the driver a less strange feeling that something is wrong, with good ease of use of the apparatus.

Furthermore, for example, in the case where the driver is going to change the vehicle-traveling direction, it is important for the driver to feel that the image displayed on liquid crystal display device 10 is close to the real image.

Thus, in the embodiment, controller 11 of display apparatus 5 transmits the image signal to liquid crystal display device 10 after the image signal has undergone the correction by image corrector 11A.

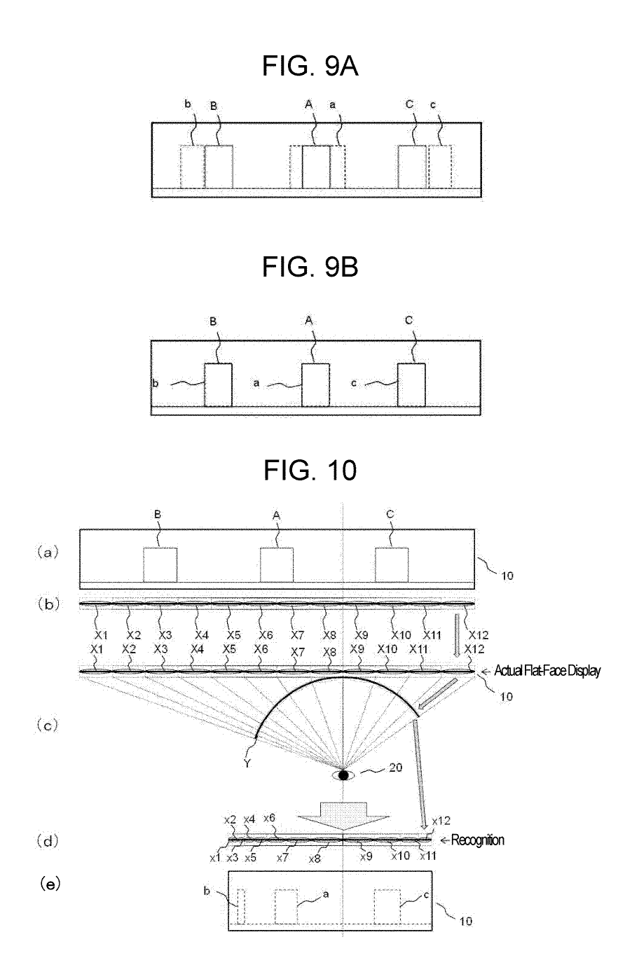

This point will be specifically described with reference to FIGS. 8, 9A, and 9B.

(a) of FIG. 8 shows the state in which liquid crystal display device 10 displays images of reference bodies A, B, and C that each have the same width, at the central, left-outward, and right-outward positions of the screen, respectively, as they are (that is, the displayed images of reference bodies A, B, and C have the widths identical to each other). However, when the driver looks in the screen of liquid crystal display device 10, such a display can give rise to an erroneous feeling (recognition) that the real images of reference bodies A, B, and C having the same width are shown as virtual images “a,” “b,” and “c” having widths different from each other as shown in FIG. 9A..

That is, central reference body A is erroneously recognized as being virtual image “a” having a wider width than the body. Reference body B is erroneously recognized as being virtual image “b” having a narrower width and locating at more left-outward position than the body.

Reference body C is erroneously recognized as being virtual image “c” having a narrower width and locating at more right-outward position than the body.

This performance gives the driver a still-remaining strange feeling that something is wrong in longitudinal visibility of the displayed image, even though the displayed image on liquid crystal display device 10 has been improved to have few time lag behind the rearview-image (real image), in the rearward direction of vehicle 1, shot with camera apparatus 8.

Hence, the embodiment is intended to provide the configuration in which the displayed image of reference bodies A, B, and C on liquid crystal display device 10 can be felt (recognized) as being virtual images “a,” “b,” and “c,” as shown in FIG. 9B, which provide the same feeling as that of the real images in terms of individual sizes and intervals therebetween.

Specifically, it is assumed that (b) of FIG. 8 shows the rearview-image in the rearward direction of vehicle 1 and shot with camera apparatus 8. In the image, spherical bodies X1, X2, X3, X4, X5, X6, X7, X8, X9, X10, X11, and X12 each having the same width are laterally aligned in a line.

Image corrector 11A of controller 11 determines the position at which each of the spherical bodies is displayed on liquid crystal display device 10, from the address of the image signal of concerned respective one of the spherical bodies. Then, in accordance with the thus-determined position, the lateral dimension of each of the spherical bodies is first compressed.

Note that the lateral dimension of (d) of FIG. 8 corresponds to the dimension of line Y developed on a lateral line. Original line Y is on a circular arc viewed from driver's eye 20.

In the case where the state shown in (c) of FIG. 8 is viewed from driver's eye 20, actual liquid crystal display device 10 is such that left- and right-outward parts of the device are more distant than the central part of the device. For this reason and as can be seen from (c) of FIG. 8, in the case where same-width spherical bodies X1, X2, X3, X4, X5, X6, X7, X8, X9, X10, X11, and X12 are displayed to be laterally aligned in a line as shown in (b) of FIG. 8, the driver erroneously feels (recognizes) same-width spherical bodies X1 to X12 as being virtual images x1 to x12 with different widths, as shown in (d) of FIG. 8.

That is, central spherical bodies X6 and X7 are erroneously recognized to have expanded widths. On the other hand, outward spherical body X1 is erroneously recognized to have a narrower width and also to shift to the left.

Moreover, outward spherical body X12 is erroneously recognized to have a narrower width and also to shift to the right.

Furthermore, even reference bodies A, B, and C with same-width shown in (a) of FIG. 8 are erroneously recognized as being virtual images “a,” “b,” and “c” having different widths as shown in (e) of FIG. 8.

Hence, in the embodiment, the image signal undergoes the following processing by image corrector 11A of controller 11. That is, the image signal is first compressed in the lateral direction, and then it is laterally expanded such that the lateral width becomes larger gradually at a greater distance away from spherical bodies X6 and X7 located at the central part of liquid crystal display device 10 toward outward spherical bodies X1 and X12, respectively.

Thereafter, liquid crystal display device 10 displays the processed image signal thereon.

As a result of this processing, when viewing the displayed image with eye 20 as shown in (c) of FIG. 8, the driver comes to feel as if spherical bodies X1, X2, X3, X4, X5, X6, X7, X8, X9, X10, X11, and X12 having widths identical to each other are laterally aligned in a line.

Moreover, reference bodies A, B, and C shown in (a) of FIG. 8 can also be displayed, such that the lateral widths of reference bodies B and C on the both sides are laterally longer than reference body A. This also causes the driver comes to feel as if reference bodies “a,” “b,” and “c” having widths identical to each other are laterally aligned in a line, as shown in FIG. 9B.

As a result, the driver can accurately understand the rearward situation, which allows appropriate driving-operation of the vehicle, resulting in excellent ease of use.

FIG. 10 is a view for illustrating the embodiment in a more realistic practice.

That is, liquid crystal display device 10 of display apparatus 5 is mounted at a mid-portion between driver's seat 3 and passenger seat 4 in vehicle interior 2 of vehicle 1, as shown in FIG. 2. Thus, the position of driver's eye 20 is shifted toward one side of liquid crystal display device 10 as shown in FIG. 10.

For this reason, even with same-width spherical bodies X1 to X12 shown in (b) of FIG. 10, spherical bodies X8 and X9 are at positions closest to the driver's eye. This causes the driver to erroneously feel (recognize) as if their real images are images x8 and x9 with larger widths shown in (d) of FIG. 10. On the other hand, because spherical body X1 is at a most distant position, the driver erroneously feels (recognizes) as if its real image is image x1 with a commensurately smaller width as shown in (d) of FIG. 10.

Moreover, in the case of same-width reference bodies A, B, and C shown in (a) of FIG. 10, because reference bodies A and C are at positions closer to eye 20, the driver erroneously feels (recognizes) as if their real images are images “a” and “c” with larger widths shown in (e) of FIG. 10. On the other hand, because reference body B is at a distant position, the driver erroneously feels (recognizes) as if its real image is image “b” with a commensurately smaller width as shown in (e) of FIG. 10.

Hence, the image is displayed in the following manner. That is, the image present in the corresponding region from central spherical body X8 to spherical body X1 is displayed on liquid crystal display device 10 such that the size of the image is larger than the size of central spherical body X8 and becomes gradually larger from central spherical body X8 to spherical body X1 at a greater distance away from the central part. Moreover, the image present in the corresponding region from central spherical body X9 to spherical body X12 is displayed on liquid crystal display device 10 such that the size of the image is larger than the size of central spherical body X9 and becomes gradually larger from central spherical body X9 to spherical body X12 at a greater distance away from the central part.

Moreover, the image of reference body B is displayed to be larger in size than the image of central reference body A when the both are displayed on liquid crystal display device 10.

As a result, the driver can accurately understand the rearward situation, which allows appropriate driving-operation of the vehicle, resulting in excellent ease of use.

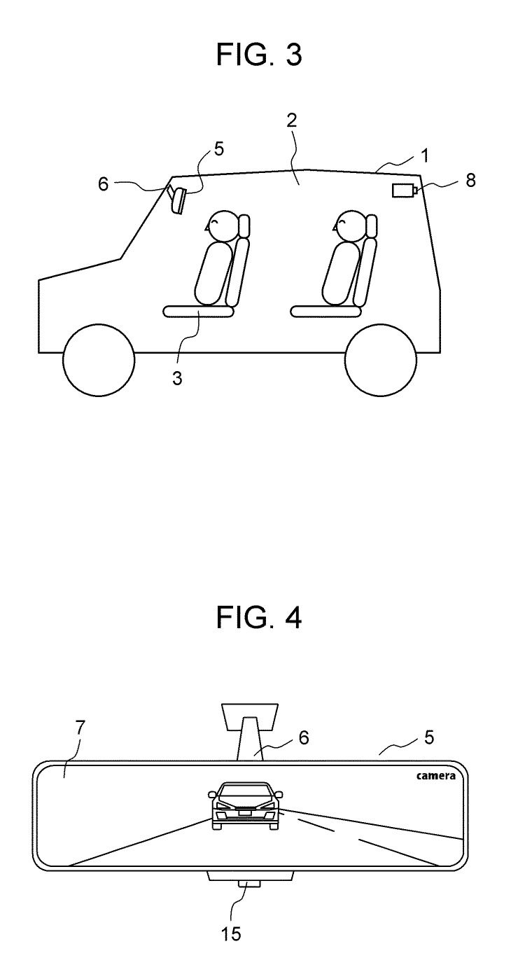

Note that, in FIGS. 2 and 3, although camera apparatus 8 is disposed in vehicle interior 2, camera apparatus 8 may be disposed in a rear part of the outside of vehicle interior 2.

### INDUSTRIAL APPLICABILITY

As described above, in a landscape-oriented display device of a display apparatus, the configuration according to the present invention is as follows:

An image is expanded such that the image becomes wider in a longitudinal direction when the image is displayed on either longitudinal side of the display device than when the image is displayed on the central part of the display device in the longitudinal direction. This configuration allows a driver to understand contents of the image in the state where the image is close (similar) to a real image, over the corresponding region from the central part of the landscape image displayed on the display device to both the longitudinal sides of the landscape image.

That is, with the landscape-oriented display device of the display apparatus, the portions of the image displayed on the longitudinal sides are expanded in the longitudinal direction compared to the portion of the image displayed on the central part, which allows a driver to recognize the image displayed along the longitudinal direction of the display device to be close to a real image, resulting in the driver's ease of appropriate driving-operation. As a result, the rear-view verification apparatus according to the present invention features excellent ease of use.

Therefore, the technology according to the present invention is expected to be applied to rear-view verification apparatuses and to vehicles equipped with the apparatuses.

### REFERENCE MARKS IN THE DRAWINGS

1 vehicle

2 vehicle interior

3 driver's seat

4 passenger seat

5 display apparatus

6 mounting part

7 display device

8 camera apparatus

9 backlight

10 liquid crystal display device

11 controller

11A image corrector

12 transmitter

13 receiver

14 storage

15 operation unit

16 receiver

17 transmitter

18 controller

19 imaging element

20 eye

1. A rear-view verification apparatus comprising:
a display apparatus disposed in front of a driver's seat inside a vehicle interior of a vehicle; and
a camera apparatus coupled with the display apparatus and capable of shooting a rearview-image in a rearward direction of the vehicle,
wherein the display apparatus including:
a display device being landscape-oriented; and
a first controller coupled with the display device and configured to cause the display device to display an image in accordance with an image signal fed from the camera apparatus, and
the first controller expands the image such that the image is wider in a longitudinal direction when the image is displayed on either longitudinal side of the display device than when the image is displayed on a central part of the display device in the longitudinal direction.

2. The rear-view verification apparatus according to claim 1,
wherein the display apparatus further includes:
a first transmitter coupled with the first controller; and
a first receiver coupled with the first controller,
the camera apparatus includes:
a second receiver coupled with the first transmitter;
a second transmitter coupled with the first receiver;
a second controller coupled with the second receiver and the second transmitter; and
an imaging element coupled with the second controller,
the first controller transmits a synchronization signal to the second controller via the first transmitter and the second receiver;
the second controller transmits the image signal to the first controller via the second transmitter and the first receiver; and
the first controller transmits the image signal to the display device.

3. The rear-view verification apparatus according to claim 2,
wherein the second controller transmits a transmission completion signal for one frame of the image to the first controller via the second transmitter and the first receiver, and
the first controller transmits a next synchronization signal to the second controller via the first transmitter and the second receiver.

4. The rear-view verification apparatus according to claim 2, wherein the imaging element is a complementary metal-oxide semiconductor (CMOS) sensor.

5. A vehicle comprising:
a vehicle interior; and
the rear-view verification apparatus according to claim 1,
wherein the camera apparatus of the rear-view verification apparatus is disposed in one of an inside of the vehicle interior and a rear part of an outside of the vehicle interior.
